(19) United States
(12) Patent Application Publication
(10) Pub. No.: US 2006/0215657 A1
(43) Pub. Date: Sep. 28, 2006

(54) ISATAP tunneling system and method between IPv4 network and IPv6 network

(76) Inventors: Min-Kyu Lee, Suwon-si (KR); Byung-Chang Kang, Yongin-si (KR)

Correspondence Address: ROBERT E. BUSHNELL, 1522 K STREET NW, SUITE 300, WASHINGTON, DC, 20005-1202, US

(21) Appl. No.: 11/271,853

(22) Filed: Nov. 14, 2005

(30) Foreign Application Priority Data
Mar. 22, 2005 (KR) 2005-23826

(51) Int. Cl. H04L 12/56

(52) U.S. Cl. 370/389; 370/466; 370/474

(57) ABSTRACT

In an Intra-Site Automatic Tunnel Addressing Protocol (ISATAP) tunneling system and method, an ISATAP tunnel which is a type of an IPv6 transition tunnel is used, even through a network address translation (NAT) region. The tunneling system for tunneling data having address formats different from one another includes: a host for encapsulating a message of a first address format in a message of a second address format; an address translator for receiving the encapsulated message of the second address format from the host, and for translating a source address of a private address format into a global address format; and a router responsive to reception of the encapsulated message of the global address format from the address translator for assigning the source address translated into the global address format as a destination address, and for transmitting to the host the message of the second address format having the assigned destination address included in prefix information.

### CLAIM OF PRIORITY

This application makes reference to, incorporates the same herein, and claims all benefits accruing under 35 U.S.C. §119 from an application for ISATAP TUNNELING SYSTEM AND METHOD BETWEEN IPv4 NETWORK AND IPv6 NETWORK earlier filed in the Korean Intellectual Property Office on Mar. 22, 2005 and there duly assigned Serial No. 10-2005-0023826.

### BACKGROUND OF THE INVENTION

1. Technical Field

The present invention relates to an IPv6 transition mechanism and, more particularly, to an Intra-Site Automatic Tunnel Addressing Protocol (ISATAP) tunneling system and method that can use an ISATAP tunnel, which is a type of IPv6 transition tunnel, even through a network address translation (NAT) region.

2. Related Art

Among Transmission Control Protocol/Internetworking Protocols (TCP/IPs), a network layer protocol is currently managed using Internetworking Protocol version 4 (IPv4). IPv4 provides host-to-host communication between systems over the Internet. Even though IPv4 is well designed, it has been reported to have defects when applied to data communication (for example, over the Internet) that has been further developed since IPv4 was established (in the 1970s).

Accordingly, in order to fix the defects, Internet Protocol version 6 (IPv6), known as Internetworking Protocol next generation (IPng), has been proposed and standardized. IPv6 has been greatly modified and adapted to the remarkably developed Internet. For example, an Internet Protocol (IP) address has been changed in format and length, together with a packet format, its related protocol (for example, an Internet control message protocol (ICMP)) has been modified, and other protocols such as an Address Resolution Protocol (ARP), Reverse Address Resolution Protocol (RARP), and Internet Group Management Protocol (IGMP) have been deleted from a network layer or included in the ICMP protocol. Also, routing protocols (for example, Routing Information Protocol (RIP), Open Shortest Path First (OSPF), and the like) have been slightly modified to adapt to the above changes.

Although systems operating based on the standardized IPv6 are under gradual development, a sudden transition from IPv4 to IPv6 cannot be made due to the enormous number of systems connected to the Internet. In other words, it will take a long time to convert all IPv4 systems connected to the Internet into IPv6 systems. Accordingly, the transition should be gradual to prevent conflict between IPv4 systems and IPv6 systems.

Strategies for facilitating the transition have been devised by the Internet Engineering Task Force (IETF). These strategies include three methods: a method of using a dual stack, a header translation method, and a tunneling method.

In the method of using a dual stack, all hosts should have a dual stack protocol until all IPv4 systems have become IPv6 systems. In other words, until all systems on the Internet use IPv6, systems should manage both IPv4 and IPv6.

The header translation method is useful when most systems on the Internet use IPv6 but some systems still use IPv4. In this method, when a sender desires to use IPv6 but a receiver is not capable of understanding IPv6, the sender translates an IPv6 header into an IPv4 header and transmits the IPv4 header.

The tunneling method is used when two computers using IPv6 communicate with each other through an IPv4 region. In other words, when an IPv6 packet enters the IPv4 region, the IPv6 packet is encapsulated in an IPv4 packet, and when the IPv6 packet is out of the IPv4 region, the IPv6 packet is decapsulated.

Specifically, the tunneling method is classified into a configured tunnel, an automatic tunnel, 6to4, an Intra-Site Automatic Tunnel Address Protocol (ISATAP) tunnel, and the like. The present invention relates to the tunneling method, and more particularly, to the ISATAP tunnel.

The ISATAP tunnel is an automatic tunneling mechanism for enabling communication between an IPv6 host and a router within an IPv4-based network.

### SUMMARY OF THE INVENTION

It is, therefore, an objective of the present invention to provide an Intra-Site Automatic Tunnel Address Protocol (ISATAP) tunneling system and method between an IPv4 network and an IPv6 network in which an ISATAP host, positioned within a network address translation (NAT) region, assigns an ISATAP global address, thereby enabling bi-directional communication through the ISATAP tunnel even in the NAT region.

Another objective of the present invention is to provide an ISATAP tunneling system and method between an IPv4 network and an IPv6 network in which, when an ISATAP tunneling method through a NAT region is used, NAT equipment need not be modified and there is no additional transmission delay.

According to an aspect of the present invention, there is provided a tunneling system for tunneling data having address formats different from one another, the system including: a host for encapsulating a message of a first address format in a message of a second address format; an address translator for receiving the encapsulated message of the second address format from the host, and translating a source address of a private address format into a global address format; and a router responsive to reception of the encapsulated message of the global address format from the address translator for assigning the source address translated into the global address format as a destination address, and for transmitting to the host the message of the second address format having the assigned destination address included in prefix information.

Preferably, the host receives the message of the second address format from the router, and assigns the prefix information of the received message as a global address of the first address format so as to generate a communication request message.

Preferably, when the router receives the generated communication request message from the host, it assigns the global address of the first address format as a destination address, and extracts a destination address of the second address format from the assigned destination address so as to generate a communication reply message in response to the communication request message.

The router may include: an address comparator which, when the router receives the encapsulated message of the global address format from the address translator, compares a source address of the first address format with a source address of the second address format so as to generate a comparison result; a controller for determining whether or not to store the source addresses of the first and second address formats depending on the generated comparison result; a routing address information database which, when it is determined from the comparison result that the source address of the first address format is not the same as the source address of the second address format, stores the source addresses of the first address format and the second address format under the control of the controller; and a message generator for assigning the stored source address of the second address format as the destination address, and for generating the message of the second address format having the assigned destination address included in the prefix information.

The generated message may include at least one of an option type field storing the prefix information, a prefix length field, and a prefix field.

According to another aspect of the present invention, there is provided a tunneling method for tunneling data having address formats different from one another, the method including the steps of: encapsulating and transmitting a message of a first address format in a message of a second address format; receiving the encapsulated message of the second address format, and translating a source address of a private address format into a global address format; and assigning the source address translated into the global address format as a destination address, and generating the message of the second address format having the assigned destination address included in prefix information.

The prefix information may be assigned to a global address of the first address format when a host generates a communication request message.

The global address of the first address format may be assigned as a destination address, and a destination address of the second address format may be extracted from the assigned destination address to generate a communication reply message in response to the communication request message.

The step of generating the message of the second address format preferably includes the steps of: comparing a source address of the first address format with a source address of the second address format in the encapsulated message of the global address format so as to generate a comparison result; determining whether or not to store the source addresses of the first address format and the second address format depending on the generated comparison result; when it is determined, from the generated comparison result, that the source address of the first address format is not the same as the source address of the second address format, storing the source addresses of the first address format and the second address format; and assigning the stored source address of the second address format as the destination address, and generating the message of the second address format having the assigned destination address included in the prefix information.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 illustrates an example of an Intra-Site Automatic Tunnel Address Protocol (ISATAP) global address format;

FIG. 2 illustrates an example of Router Advertisement/Router Solicitation (RA/RS) message delivery through an ISATAP tunnel;

FIG. 3 illustrates an example of Internet Control Message Protocol version 6 (ICMPv6) message delivery through an ISATAP tunnel;

FIG. 4 illustrates an example of RA/RS message delivery through an ISATAP tunnel in a network using a network address translation (NAT) translator;

FIG. 5 illustrates an example of ICMPv6 message delivery through an ISATAP tunnel in a network using an NAT translator;

FIG. 6 illustrates another example of ICMPv6 message delivery through an ISATAP tunnel in a network using an NAT translator;

FIG. 7 illustrates an example of RA/RS message delivery through an ISATAP tunnel in a network using an NAT translator according to the present invention;

FIG. 8 illustrates an example of a format of an RA message generated from the ISATAP router of FIG. 7;

FIG. 9 illustrates an example where in an ISATAP host, receiving the RA message of FIG. 8, assigns an IPv6 global address using ISATAP prefix information of an RA message and communicates with an IPv6 region;

FIG. 10 illustrates a construction of the ISATAP router of FIG. 9; and

FIG. 11 illustrates a process of performing bi-directional communication in an NAT region through an ISATAP tunnel according to the present invention.

### DETAILED DESCRIPTION OF THE INVENTION

Reference will now be made in detail to the preferred embodiments of the present invention, examples of which are illustrated in the accompanying drawings. Wherever possible, the same reference numerals will be used throughout the drawings to refer to the same or like parts. Related functions or constructions that are well known in the art will not be described in detail to keep the disclosure of the invention clear and concise.

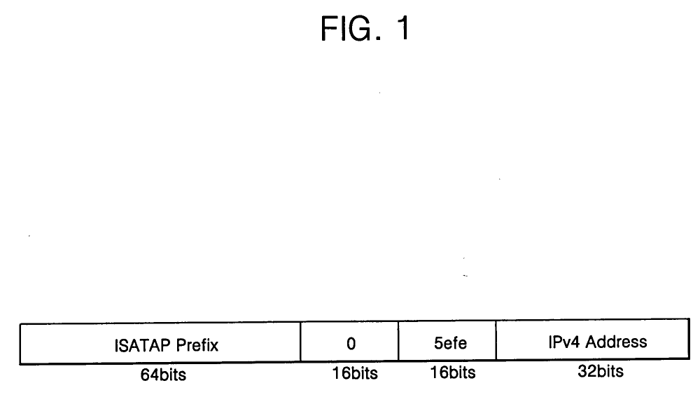

FIG. 1 illustrates an example of an Intra-Site Automatic Tunnel Address Protocol (ISATAP) global address format. The ISATAP tunnel uses an IPv6 global address format, among IPv6 address formats, such as “ISATAP Prefix::5efe:IPv4 Address”. The IPv6 global address format has an IPv4 address included in an interface identifier.

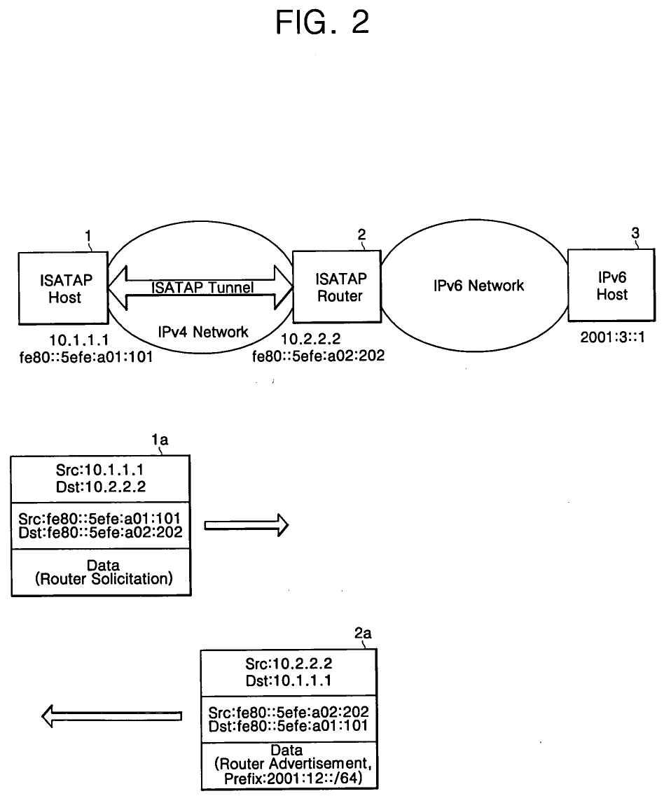

FIG. 2 illustrates an example of Router Advertisement/Router Solicitation (RA/RS) message delivery through an ISATAP tunnel.

As shown in FIG. 2, in an ISATAP site, a global address of an ISATAP host 1 is set through a Router Advertisement (RA) message of an ISATAP router 2. In other words, the ISATAP host 1 periodically transmits a Router Solicitation (RS) message to the ISATAP router 2. Whenever the ISATAP host 1 does so, the ISATAP router 2 transmits the RA message to the ISATAP host 1. The RA message includes the global address of the ISATAP host 1. In other words, the ISATAP host 1 adds an IPv6 header to data to be transmitted, and encapsulates an IPv4. The IPv6 header includes a source (hereinafter abbreviated as “Src”) address, and a destination (hereinafter abbreviated as “Dst”) address. Corresponding data are transmitted from the source address to the destination address.

In FIG. 2, the ISATAP host 1 adds an IPv6 header “Src:fe80::5efe:a01:101” and “Dst:fe80::5efe:a02:202”, and an IPv4 header having IPv4 address information such as “Src:10.1.1.1” and “Dst:10.2.2.2” included in the IPv6 header, to data to be transmitted so as to encapsulate, and transmit to the ISATAP router 2, an RS message 1a having the added IPv6 header and IPv4 header.

The ISATAP router 2 receives the RS message 1a from the ISATAP host 1 and adds an IPv6 header “Src:fe80::5efe:a02:202” and “Dst:fe80::5efe:a01:101”, and an IPv4 header having IPv4 address information such as “Src:10.2.2.2” and “Dst:10.1.1.1” included in the IPv6 header, to data to be transmitted so as to encapsulate, and transmit to the ISATAP host 1 an RA message 2a having the added IPv6 header and IPv4 header. The transmitted RA message 2a includes the global address of the ISATAP host 1. For example, when an IPv4 address is “10.1.1.1” and a prefix is “2001:12::/64” in the ISATAP host 1, an IPv6 Global ISATAP Address is set to “2001:12::5efe:0a01:0101” and an IPv6 Link-local ISATAP Address is set to “fe80::5efe:0a01:0101” in the ISATAP host 1.

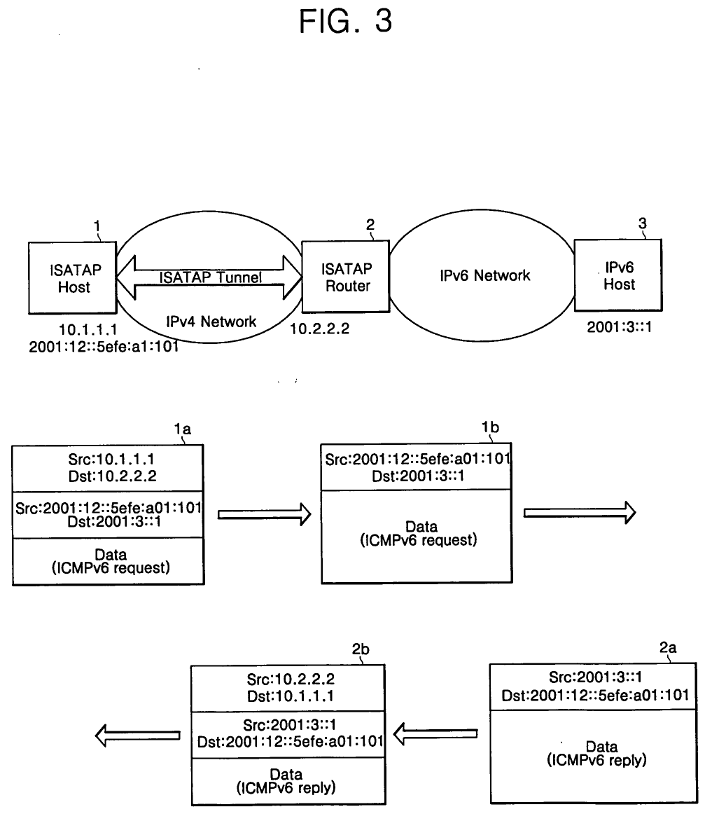

FIG. 3 illustrates an example of Internet Control Message Protocol version 6 (ICMPv6) message delivery through an ISATAP tunnel.

As shown in FIG. 3, the ISATAP host 1 adds an IPv6 header “Src:2001:12::5efe:a01:101” and “Dst:2001:3:1”, and an IPv4 header having IPv4 address information such as “Src:10.1.1.1” and “Dst:10.2.2.2” included in the IPv6 header, to data to be transmitted so as to encapsulate, and transmit to the ISATAP router 2, an ICMPv6 request message 1a having the added IPv6 header and IPv4 header. Then, the ISATAP router 2 decapsulates the ICMPv6 request message 1a, and transmits the decapsulated ICMPv6 request message 1b to an IPv6 host 3.

The ISATAP router 2 receives data (i.e., an ICMPv6 reply message) 2a having an additional IPv6 header “Src:2001:3:1” and “Dst:2001:12::5efe:a01:101” from the IPv6 host 3, and adds an IPv4 header having IPv4 address information such as “Src:10.2.2.2” and “Dst:10.1.1.1” so as to encapsulate, and transmit to the ISATAP host 1, an ICMPv6 reply message 2b having the IPv4 header.

An ISATAP tunnel in a network using Network Address Translation (hereinafter abbreviated as “NAT”), which is unlike the above-described ISATAP tunneling method, will be described below.

NAT is a method of translating a private address into a global address, and is defined in RFC3022. In NAT, internal and external NAT regions use private and global addresses, respectively, and correspond to each other using NAT equipment. NAT has been developed as a result of exhaustion of global IPv4 addresses, and has the effect of providing security.

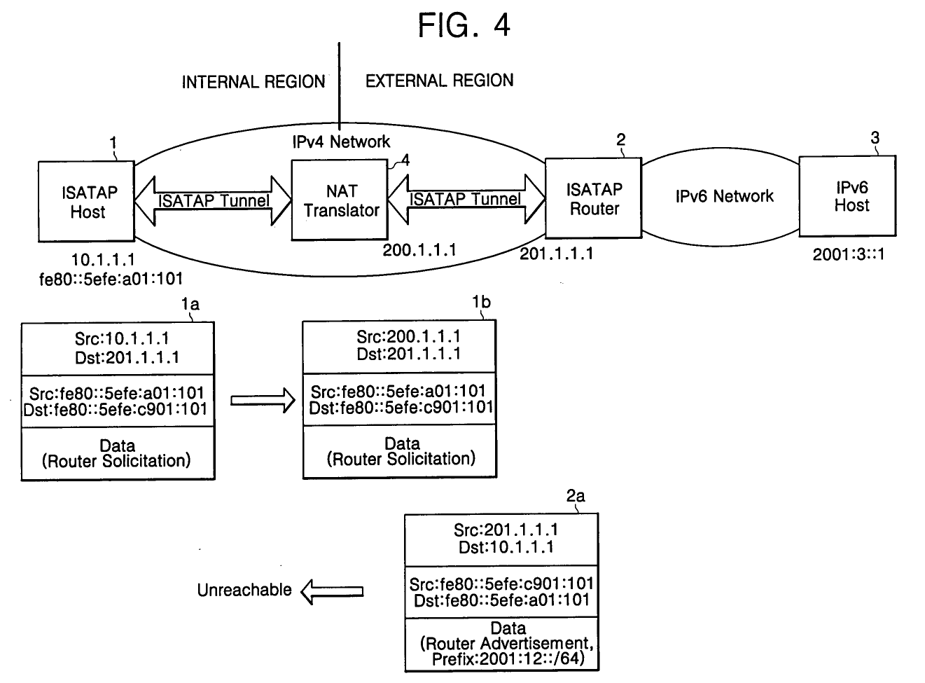

FIG. 4 illustrates an example of RA/RS message delivery through an ISATAP tunnel in a network using a Network Address Translation (NAT) translator.

As shown in FIG. 4, the ISATAP host 1 adds an IPv6 header “Src:fe80::5efe:a01:101” and “Dst:fe80::5efe:c901:101”, and an IPv4 header having IPv4 address information such as “Src:10.1:1.1” and “Dst:201.1.1.1” included in the IPv6 header, to data to be transmitted so as to encapsulate, and transmit to the NAT translator 4, an RS message 1a having the added IPv6 header and IPv4 header. Then, the NAT translator 4 translates a source address (“Src:10.1.1.1”), which is a private address of the IPv4 header of the transmitted RS message 1a, into a global address (Src:200.1.1.1”), and transmits the address-translated RS message 1b to the ISATAP router 2.

The ISATAP router 2 receives the RS message 1b from the ISATAP host 1, and adds an IPv6 header “Src:fe80::5efe:a901:101” and “Dst:fe80::5efe:c01:101”, and an IPv4 header having IPv4 address information such as “Src:201.1.1.1” and “Dst:10.1.1.1”, to data to be transmitted so as to encapsulate, and transmit to the ISATAP host 1, an RA message 2a having the IPv6 header and the IPv4 header. The destination address (“Dst:10.1.1.1”) of the IPv4 header uses an IPv4 address (“a01:101”) included in the destination address (“Dst:fe80:5efe:a01:101”) of the IPv6 header.

According to such a method, the RS message can be transmitted from the ISATAP host 1 and can reach the ISATAP router 2 via the NAT translator 4, but when the ISATAP router 2 transmits the RA message, the transmitted RA message is incapable of reaching the ISATAP host 1. This is due to the fact that, when the ISATAP router 2 encapsulates the RA message, it uses the IPv4 destination address (“Dst:10.1.1.1”) which is the private address of the ISATAP host 1, and the ISATAP router 2 does not have routing information on a corresponding IPv4 address.

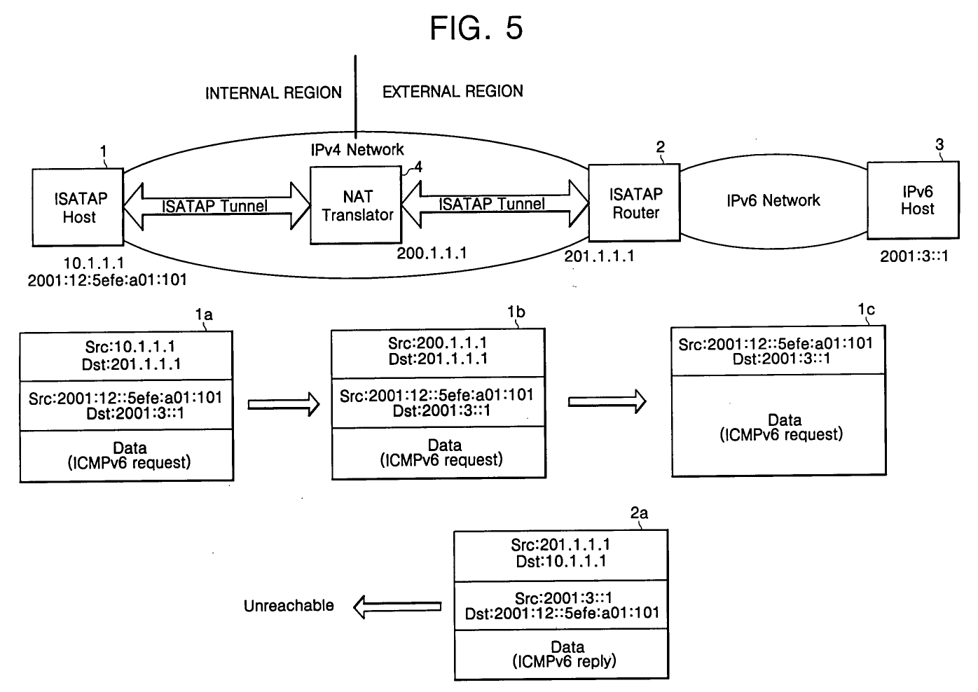

FIG. 5 illustrates an example of ICMPv6 message delivery through an ISATAP tunnel in a network using an NAT translator.

As shown in FIG. 5, the ISATAP host 1 adds an IPv6 header “Src:2001:12::5efe:a01:101” and “Dst:2001:3::1”, and an IPv4 header having IPv4 address information such as “Src:10.1.1.1” and “Dst:201.1.1.1” included in IPv6 header, to data to be transmitted so as to encapsulate, and transmit to the NAT translator 4, an ICMPv6 request message 1a having the added IPv6 header and IPv4 header.

Accordingly, the NAT translator 4 receives the ICMPv6 request message 1a from the ISATAP host 1, and translates a source address (“Src:10.1.1.1”), which is a private address of the IPv4 header of the received ICMPv6 request message 1a, into a global address (Src:200.1.1.1”) so as to transmit the ICMPv6 request message 1b having the translated IPv4 header to the ISATAP router 2.

Accordingly, the ISATAP router 2 receives the encapsulated ICMPv6 request message 1b from the NAT translator 4, decapsulates the received ICMPv6 request message 1b, and transmits the decapsulated ICMPv6 request message 1c to the IPv6 host 3.

The ISATAP router 2 receives the ICMPv6 request message 1c from the IPv6 host 3, and adds an IPv4 header having IPv4 address information such as “Src:201.1.1.1” and “Dst:10.1.1.1” to the received ICMPv6 request message 1c so as to encapsulate, and transmit to the ISATAP host 1, an ICMPv6 reply message 2a having the IPv4 header.

However, even in such a method, the ICMPv6 request message 1c can be transmitted from the ISATAP host 1 and can reach the ISATAP router 2 via the NAT translator 4, but when the ISATAP router 2 transmits the ICMPv6 reply message 2a, the transmitted ICMPv6 reply message 2a is incapable of reaching the ISATAP host 1. This is due to the fact that, when the ISATAP router 2 encapsulates the ICMPv6 reply message 2a, it uses the IPv4 destination address (“Dst:10.1.1.1”) which is the private address of the ISATAP host 1, and the ISATAP router 2 does not have routing information on a corresponding IPv4 address.

As described above, the ISATAP tunneling method has a drawback in that, when the ISATAP host is provided in an NAT internal region and the ISATAP router is provided in an NAT external region, bi-directional communication with the ISATAP host is impossible.

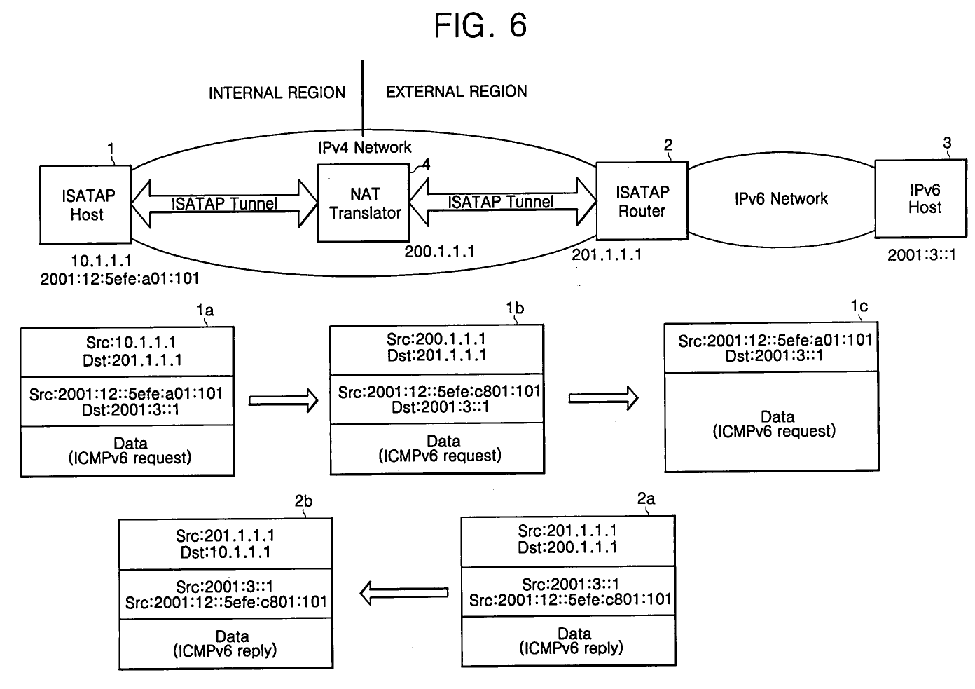

One way to overcome the above drawback is to use a method of independently processing all packets encapsulated in the ISATAP tunnel using NAT equipment. This method will be described in detail below with reference to FIG. 6.

FIG. 6 illustrates another example of ICMPv6 message delivery through the ISATAP tunnel in a network using an NAT translator.

As shown in FIG. 6, the ISATAP host 1 adds an IPv6 header “Src:2001:12::5efe:a01:101” and “Dst:2001:3::1”, and an IPv4 header having IPv4 address information such as “Src:10.1.1.1” and “Dst:201.1.1.1” included in IPv6 header, to data to be transmitted so as to encapsulate, and transmit to the NAT translator 4, an ICMPv6 request message 1a having the added IPv6 header and IPv4 header.

Accordingly, the NAT translator 4 receives the ICMPv6 request message 1a from the ISATAP host 1, and translates a source address (“Src:10.1.1.1”), which is a private address of the IPv4 header of the received ICMPv6 request message 1a, into a global address (“Src:200.1.1.1”), and concurrently translates a source address (“Src:2001:12::5efe:a01:101”), which is a private address of the IPv6 header, into a global address (“Src:2001:12::5efe:c801:101”), so as to transmit to the ISATAP router 2 the ICMPv6 request message 1b having the translated IPv4 and IPv6 headers.

Accordingly, the ISATAP router 2 receives the encapsulated ICMPv6 request message 1b from the NAT translator 4, decapsulates the received ICMPv6 request message 1b, and transmits the decapsulated ICMPv6 request message 1c to the IPv6 host 3.

The ISATAP router 2 receives the ICMPv6 request message 1c from the IPv6 host 3, and adds an IPv4 header having IPv4 address information such as “Src:201.1.1.1” and “Dst:200.1.1.1” to the received ICMPv6 request message 1c so as to encapsulate, and transmit to the NAT translator 4, an ICMPv6 reply message 2a having the IPv4 header.

Accordingly, the NAT translator 4 receives the ICMPv6 reply message 2a from the ISATAP router 2, and translates an IPv4 destination address (“Dst:200.1.1.1”), which is a global address of the received ICMPv6 reply message 2a, into a private address (“Dst:10.1.1.1”) so as to transmit the address-translated ICMPv6 reply message 2a to the ISATAP host 1.

However, this method also has a drawback in that it results in transmission delay and overloading of NAT equipment because ISATAP packets have to be modified and all packets have to be checked to determine whether they have undergone encapsulation using the ISATAP tunneling method.

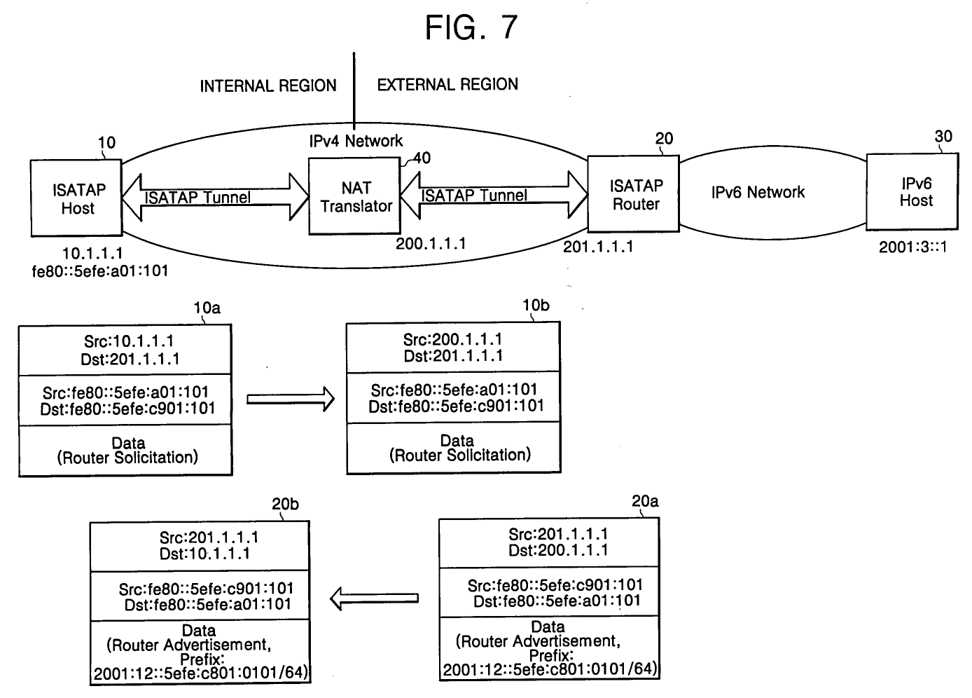

FIG. 7 illustrates an example of RA/RS message delivery through an ISATAP tunnel in a network using an NAT translator according to the present invention.

As shown in FIG. 7, an ISATAP host 10 adds an Internet Protocol version 6 (IPv6) header “Src:fe80::5efe:a01:101” and “Dst:fe80::5efe:c901:101”, and an Internet Protocol version 4 (IPv4) header having IPv4 address information such as “Src:10.1.1.1” and “Dst:201.1.1.1”, to data to be transmitted so as to encapsulate, and transmit to a NAT translator 40, a Router Solicitation (RS) message 10a having the added IPv6 header and IPv4 header.

The NAT translator 40 translates a source address (“Src:10.1.1.1”), which is a private address of the IPv4 header of the received RS message 10a, into a global address (Src:200.1.1.1”) so as to transmit the address-translated RS message 10b to an ISATAP router 20.

The ISATAP router 20 determines whether or not address translation has been performed in NAT translator 40 by comparing inner header (IPv6 header) information and outer header (IPv4 header) information of the RS message 10b. If a source address (Src) of the inner header (IPv6 header) is the same as a source address (Src) of the outer header (IPv4 header) in the RS message 10b, the ISATAP router 20 determines that address translation has not been performed in NAT translator 40. Otherwise, the ISATAP router 20 determines that address translation has been performed in NAT translator 40.

In other words, in FIG. 7, when a private IPv4 source address (“Src:fe80::5efe:a01:101”) of the inner header (IPv6 header) is not the same as a global IPv4 source address (“Src:200.1.1.1”) of the outer header (IPv4 header) in the RS message 10b, the ISATAP router 20 determines that address translation has been performed in NAT translator 40.

More specifically, when address translation has been performed in NAT translator 40, the ISATAP router 20 stores the source address (“Src:fe80::5efe:a01:101”) of the inner header (IPv6 header) and the source address (“Src:200.1.1.1”) of the outer header (IPv4 header) of the RS message 10b in a table format.

If the ISATAP router 20 receives the RS message 10b, it generates an encapsulated RA message 20a as a reply message responsive to the received RS message 10b, and transmits the generated RA message 20a to the ISATAP host 10. In this case, if the ISATAP router 20 transmits the RA message 20a by a conventional method, the RA message 20a cannot reach the ISATAP host 10. Therefore, in the present invention, the RA message 20a is generated and transmitted according to the following method.

First, when the ISATAP router 20 generates the encapsulated RA message 20a, it designates a destination address (“Dst:fe80::5efe:c901:101”) and the source address (“Src:fe80::5efe:a01:101”) of the inner header (IPv6 header) of the RS message 10b as a source address and a destination address, respectively, of an inner header (IPv6 header) of the RA message 20a.

The ISATAP router 20 designates a source address of an outer header (IPv4 header) of the RA message 20a as a destination address (“Dst:201.1.1.1”) of the outer header (IPv4 header) of the RS message (10b). In particular, unlike in a conventional method where the destination address of the outer header (IPv4 header) of the RA message 20a is extracted from the destination address (“Dst:fe80::5efe:a01:101”) of the inner header (IPv6 header) of the RA message 20a, the ISATAP router 20 designates the destination address of the outer header (IPv4 header) of the RA message 20a to the source address (“Src:201.1.1.1”) of the outer header (IPv4 header) of the RS message 10b which is stored as table information when the RS message 10b is received.

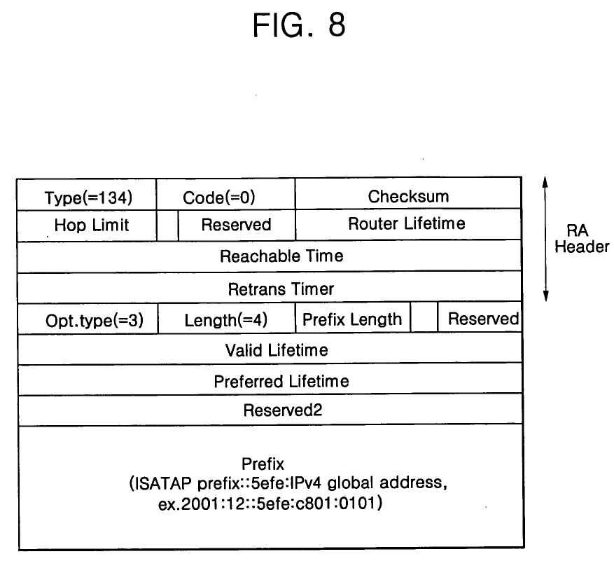

FIG. 8 illustrates an example of a format of an RA message generated from the ISATAP router of FIG. 7.

As shown in FIG. 8, the ISATAP router 20 generates the RA message 20a including option information as shown in Table 1 below.

TABLE 1

| Field | Value | Comment |
|---|---|---|
| Option type | 3 | Prefix Information |
| Prefix length | 64 | ISATAP Prefix Length |
| Prefix | 2001:12::5efe:c801:0101 | ISATAP Prefix::5efe:IPv4 |
| | | global address |

In other words, the ISATAP router 20 designates a value for each field of the RA message of FIG. 8. For example, as shown in Table 1, option type is designated as “3”, prefix length is designated as 64 bits, and prefix is designated as “2001:12::5efe:c801:0101” following the format “ISATAP Prefix::5efe:IPv4 global Address”. In this case, the “c801:0101” corresponding to the IPv4 global Address is a hexadecimal expression of the destination address (“Dst:200.1.1.1”) of the outer header (IPv4 header) of the RA message 20a.

Accordingly, the NAT translator 40 receives the RA message 20a from the ISATAP router 20, and translates the destination address (“Dst:200.1.1.1”), which is the global address of the outer header (IPv4 header) of the RA message 20a, into a private address (“Dst:10.1.1.1”) so as to transmit the address-translated RA message 20b to the ISATAP host 10.

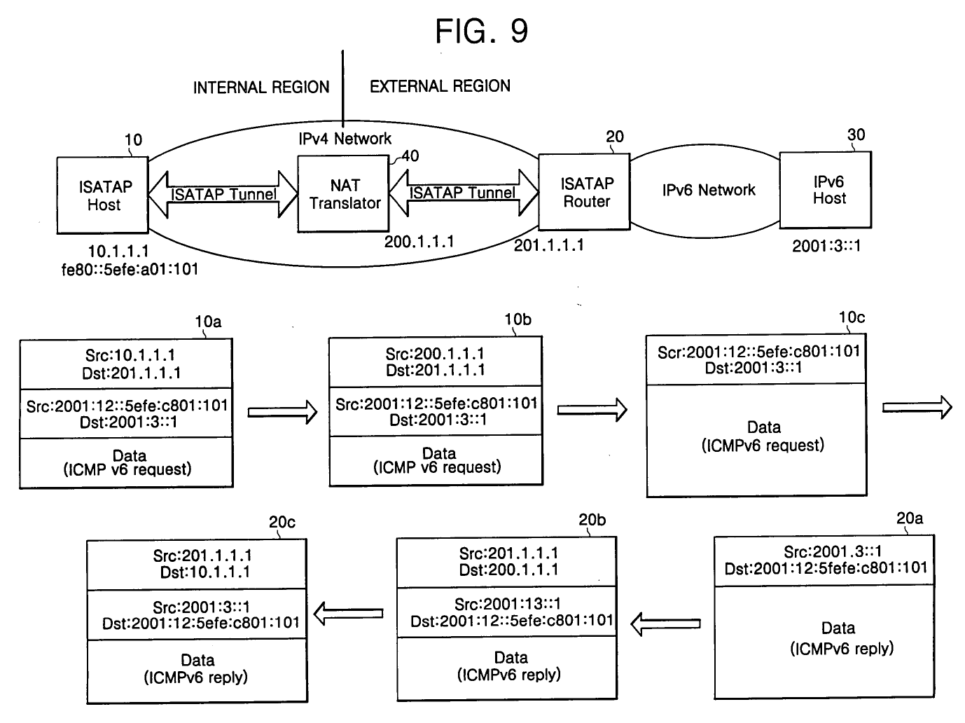

FIG. 9 illustrates an example wherein the ISATAP host, receiving the RA message of FIG. 8, assigns an IPv6 global address using ISATAP prefix information of the RA message and communicates with an IPv6 region.

As shown in FIG. 9, the IPv6 global address is assigned to the ISATAP host 10 receiving the RA message from the ISATAP router 20, using the ISATAP Prefix information of the RA message. Accordingly, the ISATAP host 10 can perform bi-directional communication with the IPv6 region, which is placed over the ISATAP router 20, using the IPv6 global address.

In other words, the ISATAP host 10 adds an IPv6 header “Src:2001:12::5efe:c801:101” and “Dst:2001:3::1”, and an IPv4 header having IPv4 address information such as “Src:10.1.1.1” and “Dst:201.1.1.1” included in IPv6 header, to data to be transmitted so as to encapsulate, and transmit to the NAT translator 40, an ICMPv6 request message 10a having the added IPv6 header and IPv4 header.

The NAT translator 40 receives the ICMPv6 request message 10a from the ISATAP host 10, and translates a source address (“Src:10.1.1.1”), which is a private address of the IPv4 header of the received ICMPv6 request message 10a, into a global address (“Src:200.1.1.1”) so as to transmit the ICMPv6 request message 10b having the address-translated header to the ISATAP router 20.

The ISATAP router 20 receives the encapsulated ICMPv6 request message 10b from NAT translator 40, decapsulates the received ICMPv6 request message 10b, and transmits the decapsulated ICMPv6 request message 10c to an IPv6 host 30.

When the IPv6 host 30 receives the ICMPv6 request message 10c from the ISATAP router 20, it adds an IPv6 header “Src:2001:3::1” and “Dst:2001:12::5efe:c801:101” to data to be transmitted so as to transmit an ICMPv6 reply message 20a having the added IPv6 header to the ISATAP router 20.

The ISATAP router 20 receives the ICMPv6 reply message 20a from IPv6 host 30, and adds an IPv4 header having IPv4 address information, such as “Src:201:1.1.1” and “Dst:200.1.1.1”, to the received ICMPv6 reply message 20a so as to encapsulate, and transmit to the NAT translator 40, an ICMPv6 reply message 20b having the added IPv4 header. In this case, the destination address (“Dst:2001:12::5efe:c801:101) of the IPv6 header corresponds to a global address, and therefore the IPv4 address (“Dst:200.1.1.1”) is also assigned as the global address since it is extracted from the destination address (“Dst:2001:12::5efe:c801:101) which is the global address.

The NAT translator 40 receives the encapsulated ICMPv6 reply message 20b from the ISATAP router 20, and translates an IPv4 destination address (“Dst:200.1.1.1”) of an IPv4 header, which is a global address of the received ICMPv6 reply message 20b, into a private address (“Dst:10.1.1.1”) so as to transmit an ICMPv6 reply message 20c having the translated address to the ISATAP host 10.

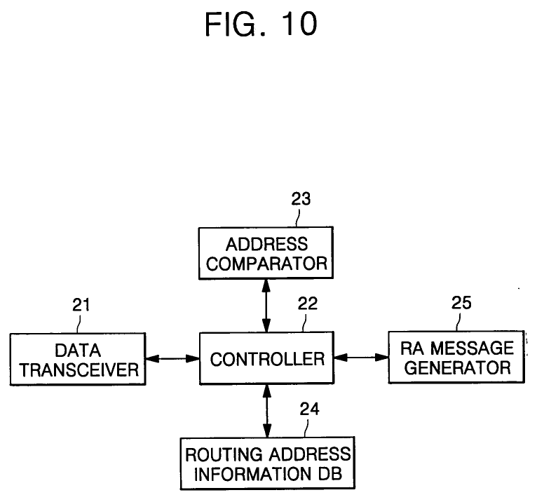

FIG. 10 illustrates a construction of the ISATAP router of FIG. 9.

As shown in FIG. 10, the inventive ISATAP router 20 includes a data transceiver 21, a controller 22, an address comparator 23, a routing address information database (DB) 24, and an RA message generator 25.

The data transceiver 21 exchanges data with the ISATAP host 10 positioned in the NAT internal region and external region.

When the controller 22 receives the RS message from the ISATAP host 10 positioned in the NAT internal region through the data transceiver 21, it transmits the received RS message to the address comparator 23.

The address comparator 23 receives the RS message from the controller 22, and compares address information of the inner header (IPv6 header) with address information of the outer header (IPv4 header) in the received RS message. In other words, the address comparator 23 compares the source address of the inner header (IPv6 header) with the source address of the outer header (IPv4 header) in the RS message, and notifies the controller 22 of the result of the source address comparison.

The controller 22 receives the comparison result from the address comparator 23, and checks the received comparison result. If the source address of the inner header (IPv6 header) is the same as the source address of the outer header (IPv4 header) in the RS message, the controller 23 determines that address translation has not been performed in NAT translator 40. Otherwise, the controller 23 determines that address translation has been performed in NAT translator 40.

In particular, if the source address of the inner header (IPv6 header) is not the same as the source address of the outer header (IPv4 header) in the RS message, the controller 22 stores the source addresses of the inner header (IPv6 header) and the outer header (IPv4 header) of the RS message in the routing address information DB 24.

The routing address information DB 24 stores the source addresses of the inner header (IPv6 header) and the outer header (IPv4 header) of the RS message in table format under the control of the controller 22.

The RA message generator 25 receives the RS message from the ISATAP host 10 positioned in the NAT internal region, and generates an RA message in response to the received RS message. That is, when the RA message generator 25 generates the RA message, it designates the source address and the destination address of the inner header (IPv6 header) of the RA message to the destination address and the source address, respectively, of the inner header (IPv6 header) of the RS message.

The RA message generator 25 also designates the source address of the outer header (IPv4 header) of the RA message to the destination address of the outer header (IPv4 header) of the RS message. Specifically, unlike a conventional method wherein the destination address of the outer header (IPv4 header) of the RA message is extracted from the destination address of the inner header (IPv6 header) of the RA message, in accordance with the invention, the destination address of the outer header (IPv4 header) of the RA message uses the source address of the outer header (IPv4 header) of the RS message stored in the routing address information DB 24 when the RS message is received.

As described above, the RA message generator 25 designates a value for each field of the RA message. Specifically, the option type is designated as “3”, the prefix length is designated as 64 bits, and the prefix is designated on the basis of the format of “ISATAP Prefix::5efe:IPv4 global Address”.

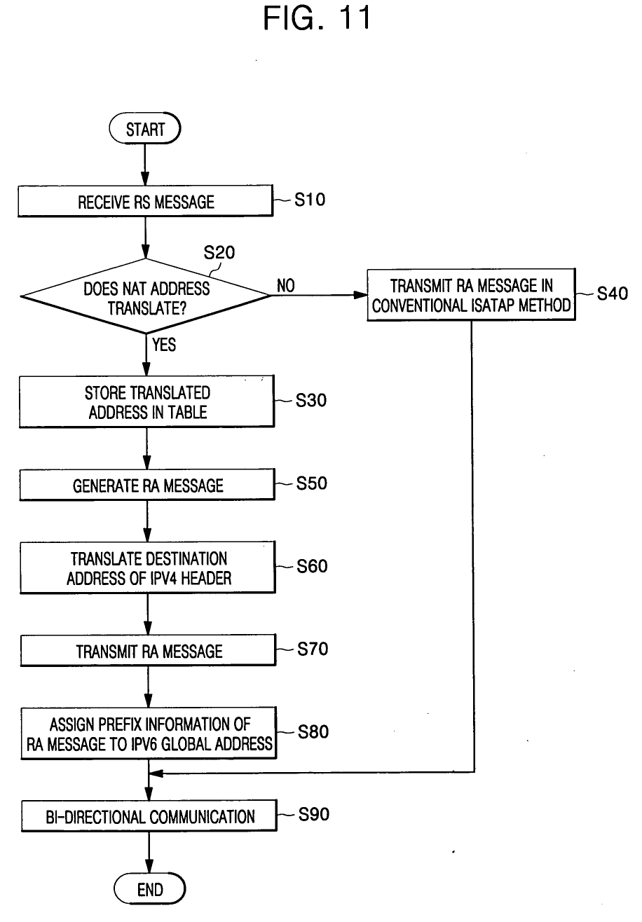

FIG. 11 illustrates a process of performing bi-directional communication in an NAT region through an ISATAP tunnel according to the present invention.

As shown in FIG. 11, the inventive ISATAP router 20 receives the RS message from the ISATAP host 10 positioned in the NAT internal region (S10).

Next, the ISATAP router 20 compares the source address of the inner header (IPv6 header) with the source address of the outer header (IPv4 header) in the received RS message so as to determine whether or not the received RS message has been address-translated via the NAT translator 40 (S20).

If the source address of the inner header (IPv6 header) is not the same as the source address of the outer header (IPv4 header) in the RS message, the ISATAP router 20 determines that the received RS message has been address-translated via the NAT translator 40 and stores the source address of the inner header (IPv6 header) and the source address of the outer header (IPv4 header) of the RS message in the table format (S30).

However, if the source address of the inner header (IPv6 header) is the same as the source address of the outer header (IPv4 header) in the RS message, the ISATAP router 20 determines that the received RS message has not been address-translated via the NAT translator 40, generates the RA message using a conventional ISATAP tunneling method, and transmits the generated RA message to the ISATAP host 10 (S40).

After step S30, the ISATAP router 20 generates the RA message in response to the RS message (S50). In other words, the source address and the destination address of the inner header (IPv6 header) of the RA message are designated to the destination address and the source address, respectively, of the inner header (IPv6 header) of the RS message.

Next, the source address of the outer header (IPv4 header) of the RA message is also designated to the destination address of the outer header (IPv4 header) of the RS message. Specifically, unlike in a conventional method wherein the destination address of the outer header (IPv4 header) of the RA message is extracted from the destination address of the inner header (IPv6 header) of the RA message, in accordance with the invention, the destination address of the outer header (IPv4 header) of the RA message uses the source address of the outer header (IPv4 header) of the RS message stored when the RS message is received.

The value of each field of the RA message is designated. Specifically, the option type is designated as “3”, the prefix length is designated as 64 bits, and the prefix is designated on the basis of the format “ISATAP Prefix::5efe:IPv4 global Address” so as to generate the RA message. After that, in the generated RA message, the destination address which is the global address of the outer header (IPv4 header) is translated into the private address using the NAT translator 40 (S60). Next, the address-translated RA message is transmitted to the ISATAP host 10 (S70).

The ISATAP host 10 receives the RA message, and assigns the prefix information of the received RA message to the IPv6 global address (S80) so as to enable bi-directional communication with the IPv6 host of the IPv6 region (S90).

As described above, the present invention has an effect such that the ISATAP host positioned within the NAT region can assign the ISATAP global address, thereby enabling bi-directional communication through the ISATAP tunnel, even in the NAT region.

Furthermore, the present invention has such an effect that, when the method of the ISATAP tunnel through NAT region is used, NAT equipment need not be modified and there is no additional transmission delay.

While the present invention has been described with reference to exemplary embodiments thereof, it will be understood by those skilled in the art that various changes in form and detail may be made therein without departing from the scope of the present invention as defined by the following claims.

What is claimed is:

1. A tunneling system for tunneling data having address formats different from one another, the system comprising:
a host for encapsulating a message of a first address format in a message of a second address format;
an address translator for receiving the encapsulated message of the second address format from the host, and for translating a source address of a private address format into a global address format; and
a router responsive to reception of the encapsulated message of the global address format from the address translator for assigning the source address translated into the global address format as a destination address, and for transmitting to the host the message of the second address format having the assigned destination address included in prefix information.

2. The system according to claim 1, wherein the host receives the message of the second address format from the router, and assigns the prefix information of the received message to a global address of the first address format so as to generate a communication request message.

3. The system according to claim 2, wherein, when the router receives the generated communication request message from the host, the router assigns the global address of the first address format as a destination address and extracts a destination address of the second address format from the assigned destination address so as to generate a communication reply message in response to the communication request message.

4. The system according to claim 1, wherein the router comprises:
an address comparator responsive to reception, by the router, of the encapsulated message of the global address format from the address translator for comparing a source address of the first address format with a source address of the second address format so as to generate a comparison result;
a controller for determining whether to store the source addresses of the first and second address formats, respectively, depending on the generated comparison result;
a routing address information database responsive to a determination, from the comparison result, that the source address of the first address format is not the same as the source address of the second address format for storing the source addresses of the first address format and the second address format, respectively, under the control of the controller; and
a message generator for assigning the stored source address of the second address format as the destination address, and for generating the message of the second address format having the assigned destination address included in the prefix information.

5. The system according to claim 4, wherein the generated message comprises at least one of an option type field storing the prefix information, a prefix length field, and a prefix field.

6. A routing device of a tunneling system for tunneling data having address formats different from one another, the routing device comprising:
an address comparator for receiving an encapsulated message of a second address format from a host encapsulating a message of a first address format in a message of the second address format, and for comparing a source address of the first address format with a source address of the second address format to generate a comparison result;
a controller for determining whether to store the source addresses of the first address format and the second address format, respectively, depending on the generated comparison result;
a routing address information database responsive to a determination, from the generated comparison result, that the source address of the first address format is not the same as the source address of the second address format for storing the source addresses of the first address format and the second address format, respectively, under the control of the controller; and
a message generator for assigning the source address of the second address format stored in the routing address information database as a destination address, and for generating the message of the second address format having the assigned destination address included in prefix information.

7. The routing device according to claim 6, wherein the generated message comprises at least one of an option type field storing the prefix information, a prefix length field, and a prefix field.

8. A tunneling method for tunneling data having address formats different from one another, the method comprising the steps of:
encapsulating and transmitting a message of a first address format in a message of a second address format;
receiving the encapsulated message of the second address format, and translating a source address of a private address format into a global address format;
assigning the source address translated into the global address format as a destination address; and
generating the message of the second address format having the assigned destination address included in prefix information.

9. The method according to claim 8, wherein the prefix information of the message of the second address format is assigned to a global address of the first address format when a host generates a communication request message.

10. The method according to claim 9, wherein the global address of the first address format is assigned as a destination address, and a destination address of the second address format is extracted from the assigned destination address to generate a communication reply message in response to the communication request message.

11. The method according to claim 8, wherein the step of generating the message of the second address format comprises the steps of:
comparing a source address of the first address format with a source address of the second address format in the encapsulated message of the global address format so as to generate a comparison result;
determining whether to store the source addresses of the first address format and the second address format, respectively, depending on the generated comparison result;
when it is determined from the generated comparison result that the source address of the first address format is not the same as the source address of the second address format, storing the source addresses of the first address format and the second address format, respectively;
assigning the stored source address of the second address format as the destination address; and
generating the message of the second address format having the assigned destination address included in the prefix information.

12. The method according to claim 11, wherein the message of the second address format comprises at least one of an option type field storing the prefix information, a prefix length field, and a prefix field.
